(19) United States
(12) Patent Application Publication
(10) Pub. No.: US 2017/0344853 A1
(43) Pub. Date: Nov. 30, 2017

(54) IMAGE PROCESSING APPARATUS AND METHOD FOR EASILY REGISTERING OBJECT

(71) Applicant: TOSHIBA TEC KABUSHIKI KAISHA, Tokyo (JP)

(72) Inventors: Hitoshi Iizaka, Fuji Shizuoka (JP); Hidehiko Miyakoshi, Mishima Shizuoka (JP); Hidehiro Naitou, Mishima Shizuoka (JP); Yuichiro Hatanaka, Mishima Shizuoka (JP); Yuta Sasaki, Izunokuni Shizuoka (JP)

(21) Appl. No.: 15/603,589

(22) Filed: May 24, 2017

(30) Foreign Application Priority Data
May 26, 2016 (JP) 2016-105577

(51) Int. Cl. G06K 9/62; G06Q 20/20; G06F 17/30

(52) U.S. Cl. CPC G06K 9/6215; G06Q 20/208; G06Q 20/201; G06K 9/6202; G06F 17/30259

(57) ABSTRACT

In accordance with an embodiment, an image processing apparatus comprises a designation module, a registration module and a display control module. The designation module designates an object. The registration module registers information of the object designated by the designation module. The display control module enables a display section to display an operation section for instructing the registration module based on the information registered by the registration module.

### CROSS-REFERENCE TO RELATED APPLICATIONS

This application is based upon and claims the benefit of priority from Japanese Patent Application No. 2016-105577, filed May 26, 2016, the entire contents of which are incorporated herein by reference.

### FIELD

Embodiments described herein relate generally to an information processing apparatus and a method for easily registering an object.

### BACKGROUND

Conventionally, there is a general object recognition (object recognition) technology in which a feature amount of a target object, e.g., a commodity, extracted from a captured image data is compared with a feature amount for comparison stored beforehand to obtain a similarity degree therebetween, and a category of the object is recognized according to the similarity degree.

An information processing apparatus in which the target object is recognized with the general object recognition requires selection of the target object from candidates of the object to prevent incorrectness of the general object recognition if the similarity degree is smaller than a threshold value.

The information processing apparatus identifies a corresponding object for each target object. Thus, even if a plurality of commodities belonging to the same category is registered, the same operation needs to be repeated and there is room for improvement on the operability of the information processing apparatus.

### DESCRIPTION OF THE DRAWINGS

FIG. 1 is a perspective view illustrating an example of a checkout system according to a first embodiment;

FIG. 2 is a block diagram illustrating an example of the hardware structures of a POS terminal and a commodity reading apparatus;

FIG. 3 is a view illustrating an example of the data structure of a PLU file;

FIG. 4 is a block diagram illustrating characteristic functional components included in the POS terminal;

FIG. 5 is a view illustrating an example of the data structure of an image data table;

FIG. 6 is a view illustrating an example of the data structure of a sales registration table;

FIG. 7 is a view illustrating an example of a commodity registration screen;

FIG. 8 is a view illustrating an example of a commodity registration screen;

FIG. 9 is a flowchart illustrating an example of a commodity registration processing executed by the POS terminal according to the first embodiment;

FIG. 10 is a view illustrating an example of the data structure of a sales registration table according to a second embodiment;

FIG. 11 is a view illustrating an example of a commodity registration screen;

FIG. 12 is a flowchart illustrating an example of a commodity registration processing executed by the POS terminal according to the second embodiment;

FIG. 13 is a perspective view illustrating an example of the constitution of a self-checkout POS terminal; and

FIG. 14 is a block diagram illustrating an example of the hardware structure of the self-checkout POS terminal.

### DETAILED DESCRIPTION

In accordance with an embodiment, an image processing apparatus comprises a designation module, a registration module and a display control module. The designation module designates an object. The registration module registers information of the object designated by the designation module. The display control module enables a display section to display an operation section for instructing the registration module based on the information registered by the registration module.

Hereinafter, with reference to the accompanying drawings, an information processing apparatus and a method for easily registering an object according to an embodiment is described in detail. The embodiment described herein is merely an embodiment of the information processing apparatus and the method for easily registering the object, and is not intended to limit the constitution and specification thereof. The present embodiment is an example of application to a checkout system introduced to a store such as a supermarket and the like.

### First Embodiment

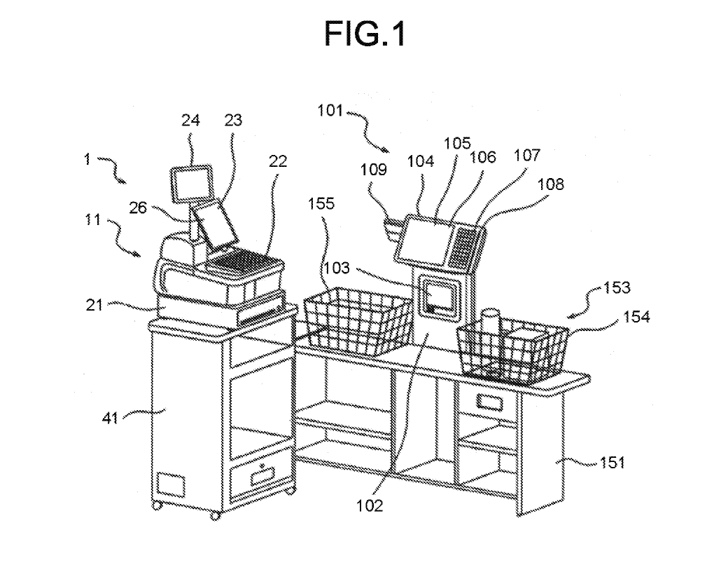

FIG. 1 is a perspective view illustrating an example of a checkout system 1 according to the first embodiment. The checkout system 1 includes a commodity reading apparatus 101 for reading information relating to a commodity and a POS (Point Of Sales) terminal 11 for carrying out a sales registration and a settlement of commodities in one transaction. Hereinafter, an example in which the POS terminal 11 is applied as the information processing apparatus according to the first embodiment is described. As an example of a target object of the general object recognition, a case in which the target object is a commodity is described; however, the target object may be other objects except for the commodity.

The POS terminal 11 is placed on a drawer 21 on a checkout counter 41. The drawer 21 is opened or closed under the control of the POS terminal 11. The POS terminal 11 is provided with a keyboard 22 operated by an operator (shop clerk) on the upper surface thereof. The POS terminal 11 is also provided with a first display section 23 for displaying various information to the operator behind the keyboard 22 if viewed from the operator who operates the keyboard 22. The first display section 23 is provided with a touch panel 26 for receiving various operations. The POS terminal 11 further includes a second display section 24 vertically arranged to be rotatable behind the first display section 23. The second display section 24 shown in FIG. 1 faces a front side in FIG. 1; however, the second display section 24 is rotated to direct to the back side in FIG. 1 to display various information to a customer.

The counter table 151, e.g., a horizontally elongated table, is arranged to be in an L-shape with the checkout counter 41 on which the POS terminal 11 is placed. A shopping basket 153 which receives a commodity therein is placed on the counter table 151. The shopping basket 153, which is not limited to a so-called basket shape, may be a tray. The shopping basket 153 may be formed in a box shape, a bag shape and the like. The shopping basket 153 includes a first shopping basket 154 carried by the customer and a second shopping basket 155 placed on the counter table 151 to face the first shopping basket 154 across the commodity reading apparatus 101.

The commodity reading apparatus 101, connected with the POS terminal 11 to be capable of sending and receiving data, is arranged on the counter table 151. The commodity reading apparatus 101 includes a thin rectangular-shaped housing 102. A reading window 103 is formed on the front surface of the housing 102. A display and operation section 104 is mounted at the upper portion of the housing 102.

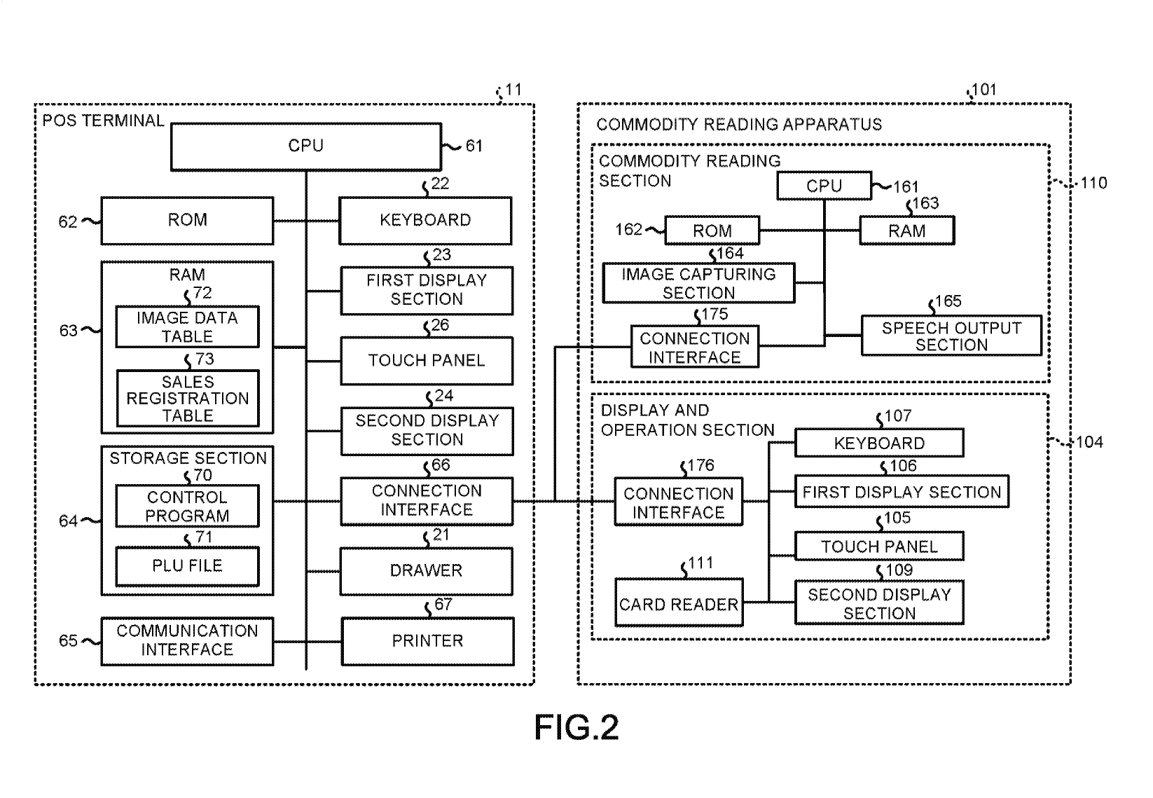

The display and operation section 104 is equipped with a first display section 106 on the surface of which a touch panel 105 is overlaid. A keyboard 107 of the commodity reading apparatus 101 is arranged at the right side of the first display section 106. A card reading slot 108 of a card reader 111 (refer to FIG. 2) is arranged at the right side of the keyboard 107 of the commodity reading apparatus 101. A second display section 109 for providing information to the customer is arranged at the left backside of the display and operation section 104 in the commodity reading apparatus 101 if viewed from the operator.

The commodity reading apparatus 101 includes a commodity reading section 110 (refer to FIG. 2) inside the housing 102. The commodity reading section 110 is provided with an image capturing section 164 (refer to FIG. 2) at the rear side of the reading window 103.

The first shopping basket 154 receives commodities relating to one transaction. The operator who operates the commodity reading apparatus 101 moves the commodities in the first shopping basket 154 one by one to the second shopping basket 155. During the movement, the operator holds the commodity over the reading window 103 of the commodity reading apparatus 101. At this time, the image capturing section 164 (refer to FIG. 2) arranged inside the reading window 103 photographs the commodity.

FIG. 2 is a block diagram illustrating an example of the hardware structures of the POS terminal 11 and the commodity reading apparatus 101. The POS terminal 11 includes a CPU (Central Processing Unit) 61, a ROM (Read Only Memory) 62, a RAM (Random Access Memory) 63, a storage section 64, a communication interface 65, a keyboard 22, the first display section 23, the touch panel 26, the second display section 24, a connection interface 66, a drawer 21, and a printer 67. The CPU 61, the ROM 62, the RAM 63, the storage section 64, the communication interface 65, the keyboard 22, the first display section 23, the touch panel 26, the second display section 24, the connection interface 66, the drawer 21, and the printer 67 are connected via a bus line.

The CPU 61 collectively controls the operation of the POS terminal 11. The ROM 62 stores various programs and data. The RAM 63 temporarily stores various programs and also stores various data in a rewritable manner. The RAM 63 stores an image data table 72 described later and a sales registration table 73 described later. The image data table 72 and the sales registration table 73 are not limited to being stored in the RAM 63 and may be stored in another storage medium such as the storage section 64 or may be stored in another device such as a store server.

The keyboard 22 is provided with various keys for operating the POS terminal 11. For example, the keyboard 22 is provided with a closing key for ending a commodity registration processing for registering commodities relating to one transaction.

The storage section 64 is a nonvolatile storage device such as an HDD (Hard Disk Drive), an SSD (Solid State Drive), etc. The storage section 64 stores a control program 70 and a PLU file 71. The PLU file 71 is not limited to being stored in the storage section 64, and may be stored in another storage medium or may be stored in another device such as the store server.

The control program 70 is an operating system or a program for realizing the functions of the POS terminal 11. The control program 70 includes a program for realizing the distinctive functions according to the present embodiment.

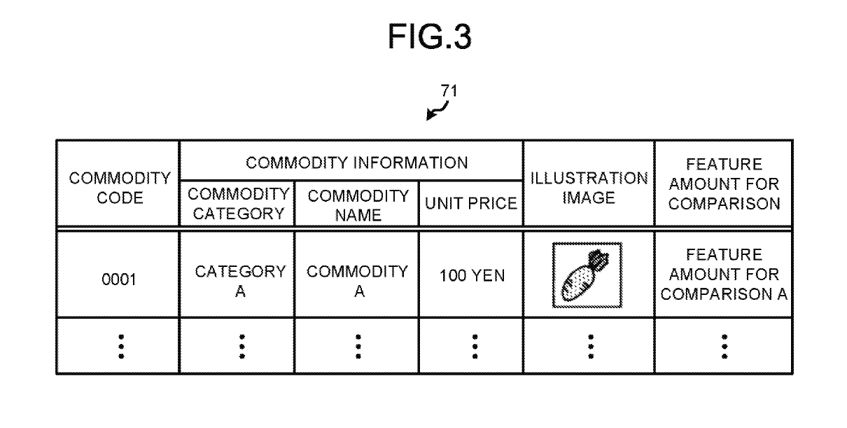

The PLU file 71 is a commodity file in which information relating to a sales registration of a commodity is stored for each of various commodities displayed in the store to be sold. FIG. 3 is a view illustrating an example of the data structure of the PLU file 71. The PLU file 71 stores a commodity code, a commodity information, an illustration image and a feature amount for comparison in an associated manner for each commodity. The commodity code is capable of identifying a commodity. The commodity information includes a commodity category to which the commodity belongs, a commodity name, a unit price and the like. The illustration image shows the commodity. The feature amount for comparison is obtained by parameterizing appearance features such as a standard shape, surface tint, pattern, concave-convex state and the like of commodity. The feature amount for comparison is data for comparison used for determination of a similarity degree described later.

Returning to FIG. 2, the CPU 61 of the POS terminal 11 is connected to the communication interface 65. The communication interface 65 is used to communicate with an external device such as a store computer via a network.

The connection interface 66 is used for connecting with the commodity reading apparatus 101. The printer 67 prints transaction contents in one transaction on a receipt paper.

The commodity reading section 110 of the commodity reading apparatus 101 includes a CPU 161, a ROM 162, a RAM 163, the image capturing section 164, a speech or voice output section 165, and a connection interface 175. The CPU 161, the ROM 162, the RAM 163, the image capturing section 164, the speech output section 165, and the connection interface 175 are connected via a bus line.

The CPU 161 collectively controls the operation of the commodity reading apparatus 101. The ROM 162 stores various programs and data. The RAM 163 temporarily stores various programs and also stores various data in a rewritable manner.

The image capturing section 164 includes an image sensor (not shown) such as a color CCD image sensor and a color CMOS image sensor, and a light source (not shown) such as an LED. The image capturing section 164 captures an image through the reading window 103 under the control of the CPU 161. For example, the image capturing section 164 captures the image data at a frame rate such as 30 fps (Frame Per Second). The image capturing section 164 stores the image data sequentially captured in the RAM 163.

The speech output section 165 includes a sound circuit, a speaker and the like for generating a preset warning sound. The speech output section 165 carries out notification by issuing a warning sound or a voice under the control of the CPU 161.

The connection interface 175 connects with the POS terminal 11 and the display and operation section 104.

The display and operation section 104 of the commodity reading apparatus 101 includes a connection interface 176, the keyboard 107, the first display section 106, the touch panel 105, the second display section 109, and the card reader 111. The connection interface 176, the keyboard 107, the first display section 106, the touch panel 105, the second display section 109, and the card reader 111 are connected via a bus line.

The connection interface 176 is used for connecting with the POS terminal 11 and the commodity reading section 110.

The card reader 111 reads information stored in a storage medium of a card used for settlement such as a credit card. The card reader 111 reads information stored in a storage medium of a card if the card is inserted into the card reading slot 108, in other words, if the card is slid along the card reading slot 108.

The operation of the display and operation section 104 is controlled by the CPU 161 of the commodity reading section 110 or the CPU 61 of the POS terminal 11.

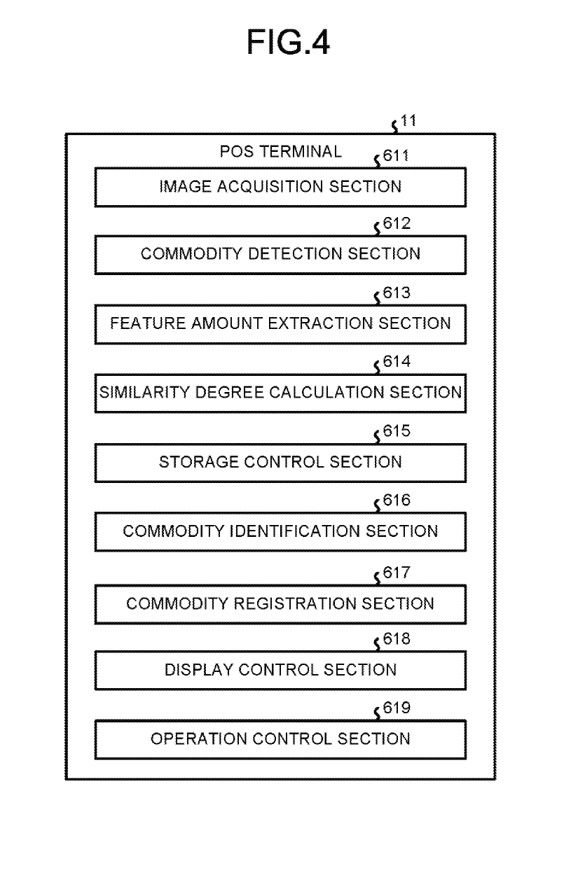

The distinctive functions included in the POS terminal 11 are described. FIG. 4 is a block diagram illustrating the characteristic functional components of the POS terminal 11. The CPU 61 copies or decompresses the control program 70 in the storage section 64 on the RAM 63 and operates according to the control program 70 to generate each functional section shown in FIG. 4 on the RAM 63. Specifically, the CPU 61 includes, as functional sections, an image acquisition section 611, a commodity detection section 612, a feature amount extraction section 613, a similarity degree calculation section 614, a storage control section 615, a commodity identification section 616, a commodity registration section 617, a display control section 618, and an operation control section 619.

The image acquisition section 611 outputs an image capturing request to the image reading apparatus 101 to enable the image capturing section 164 to start an image capturing operation. The image capturing section 164 stores the image data captured sequentially in the RAM 163. The commodity reading apparatus 101 sequentially outputs the image data stored in the RAM 163 to the image acquisition section 611 of the POS terminal 11. Then, the image acquisition section 611 sequentially receives the input of the image data captured by the image capturing section 164.

The commodity detection section 612, i.e., a detection module, detects the commodity contained in the image data received by the image acquisition section 611. For example, the commodity detection section 612 detects a part or all of the commodity contained in the image data with a pattern matching technology. Specifically, the commodity detection section 612 extracts a contour line from a binary image of the image data. The commodity detection section 612 detects the commodity based on a difference between a contour line extracted from the image data prepared in advance and a contour line extracted from the image data to be detected. The image data prepared in advance is obtained at the time the image capturing section 164 captures a background not containing the commodity. Thus, the commodity detection section 612 can detect the contour line not contained in the contour line extracted from the image data prepared in advance from the contour line extracted from the image data to be detected on condition that the commodity is contained in the image data to be detected. The commodity detection section 612 detects the commodity based on the contour line not contained in the contour line extracted from the image data prepared in advance.

The feature amount extraction section 613 extracts the state of the surface such as the tint and the concave-convex state of the surface of the commodity detected by the commodity detection section 612 from the image data captured by the image capturing section 164 as a feature amount.

The similarity degree calculation section 614 calculates a similarity degree with each commodity registered in the PLU file 71 by comparing the feature amount for comparison of the commodity registered in the PLU file 71 with the feature amount of the commodity extracted by the feature amount extraction section 613. In a case in which the feature amount for comparison of the commodity stored in the PLU file 71 is set to 100%=“similarity degree: 1.0”, the similarity degree indicates how much similar the feature amount of a part or all of the commodity is to that of the registered commodity. For example, in the tint and the surface concave-convex state, the similarity degree calculation section 614 changes the weighting to calculate the similarity degree.

The recognition of an object contained in an image as stated above is referred to as a general object recognition. As to the general object recognition, various recognition technologies are described in the following document.

Keiji Yanai “Present situation and future of generic object recognition”, Journal of Information Processing Society, Vol. 48, No. SIG16 [Search on Heisei 28 April 29th], Internet <URL: http://mm.cs.uec.ac.jp/IPSJ-TCVIM-Yanai.pdf>

In addition, the technology for carrying out the general object recognition by performing an area-division to the image for each object is described in the following document.

Jamie Shotton et.al, “Semantic Texton Forests for Image Categorization and Segmentation”, [Search on Heisei 28 April 29th], Internet <URL: http://citeseerx.ist.psu.edu/viewdoc/download?doi=10.1.1.145.3036&rep=rep1&type=pdf>

Furthermore, the method for calculating the similarity degrees between the feature amount for comparison of various commodities registered in the PLU file 71 and the feature amount of the commodity extracted by the feature amount extraction section 613 is not particularly limited. For example, the similarity degree calculation section 614 may calculate the similarity degree between the feature amount for comparison of the commodity registered in the PLU file 71 and the feature amount of the commodity extracted by the feature amount extraction section 613 as an absolute evaluation or as a relative evaluation.

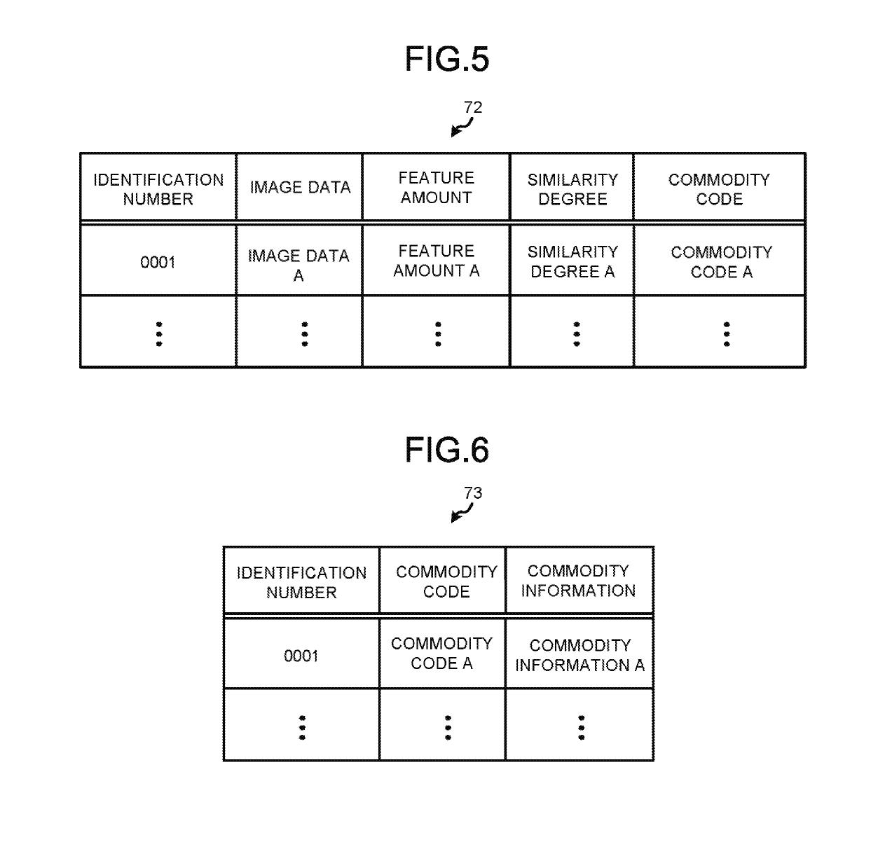

The storage control section 615 stores the image data captured by the image capturing section 164 in the image data table 72. FIG. 5 is a view illustrating an example of the data structure of the image data table 72. The image data table 72 stores one or plural sets in which the identification number, the image data, the feature amount, the similarity degree, and the commodity code are set in an associated manner. The identification number is capable of identifying information stored in the image data table 72. The image data is received by the image acquisition section 611. In other words, the image data is used in the general object recognition of the commodity contained in the image data. The feature amount is extracted by the feature amount extraction section 613 as to the commodity contained in the associated image data. The similarity degree is the highest similarity degree among the similarity degrees between the feature amount of the commodity contained in the associated image data and the feature amount for comparison of various commodities registered in the PLU file 71. The commodity code is a code of the commodity with the highest similarity degree. The storage control section 615 deletes all the image data stored in the image data table 72 on condition that the commodity is sales-registered. The storage control section 615 is not limited to storing the image data, the feature amount, the similarity degree and the commodity code in the same data table, and may store them in different data tables.

Returning to FIG. 4, the commodity identification section 616, i.e., an extraction module, extracts commodity information of the commodity corresponding to the commodity contained in the image data from the PLU file 71 based on the similarity degree stored in the image data table 72. In other words, the commodity identification section 616 extracts commodity information of the commodity photographed by the image capturing section 164. In the present embodiment, the commodity identification section 616 extracts commodity information in such a manner that the commodity information is classified to a confirmed commodity, a commodity candidate or an unidentifiable commodity according to the similarity degree stored in the image data table 72. The classification according to the similarity degree is merely an example, and the classification may be determined by other methods.

The commodity identification section 616 determines whether or not a predetermined number or more of the similarity degrees equal to or greater than a first threshold value are registered as to the same commodity in the image data table 72 as a first condition. The commodity identification section 616 extracts the commodity corresponding to the commodity detected by the commodity detection section 612 from the PLU file 71 as the confirmed commodity on condition that the first condition is fulfilled. The commodity identification section 616 extracts the commodity information of the confirmed commodity from the PLU file 71. The confirmed commodity refers to a commodity that can be automatically registered based on the similarity degree stored in the image data table 72 without carrying out a confirmation operation by the operator. The automatic registration refers to a processing of registering the confirmed commodity as the commodity subject to be sold without requiring the confirmation operation by the operator.

The commodity identification section 616 determines whether or not a predetermined number or more of the similarity degrees equal to or greater than a second threshold value are registered as to the same commodity in the image data table 72 as a second condition on condition that the first condition is not fulfilled. The second threshold value is smaller than the first threshold value. The commodity identification section 616, i.e., an extraction module, extracts one or a plurality of the commodities corresponding to the commodity detected by the commodity detection section 612 from the PLU file 71 as commodity candidates on condition that the second condition is fulfilled. The commodity identification section 616 extracts the commodity information of the commodity candidates from the PLU file 71. The commodity candidate refers to candidate of the commodity corresponding to the commodity detected by the commodity detection section 612 based on the similarity degree stored in the image data table 72. In other words, the commodity candidate is candidate of the commodity photographed by the image capturing section 164. The commodity candidate is sales-registered as the commodity to be sold through the confirmation operation by the operator, i.e., an operation of selecting the corresponding commodity from one or a plurality of the commodity candidates.

The commodity identification section 616 determines that the commodity is unidentifiable on condition that the second condition is not fulfilled. The commodity identification section 616 extracts no commodity information from the PLU file 71 on condition that it is determined that the commodity is unidentifiable.

The commodity registration section 617 executes the sales registration on a commodity designated by a designation module such as the commodity identification section 616 as the commodity subject to be sold. In other words, the commodity registration section 617 sales-registers the commodity information of the commodity subject to be sold. The commodity registration section 617 carries out the sales registration on the corresponding commodity as the commodity subject to be sold if the commodity identification section 616 determines the corresponding commodity as the confirmed commodity. Alternatively, the commodity registration section 617 carried out the sales registration on a commodity selected from the commodity candidates as the commodity subject to be sold if the commodity identification section 616 extracts the commodities as the commodity candidates. The commodity registration section 617 sales-registers a commodity specified by the commodity code indicated by a code symbol as the commodity to be sold even if the image capturing section 164 reads the code symbol.

More specifically, the commodity registration section 617, i.e., a registration module, registers various information of the commodity designated as the commodity to be sold by the commodity identification section 616 in the sales registration table 73. FIG. 6 is a view illustrating an example of the data structure of the sales registration table 73. The sales registration table 73 stores the identification number, the commodity code and the commodity information in an associated manner. The identification number is capable of identifying information stored in the sales registration table 73. The commodity code is a code of the commodity to which the sales remigration is executed. The commodity information is information of the commodity specified with the associated commodity code. The commodity registration section 617 sends the information stored in the sales registration table 73 to a store server if a commodity registration processing for registering the commodities relating to one transaction is ended. Further, the commodity registration section 617 deletes the information stored in the sales registration table 73.

The display control section 618 controls a part or all of the first display section 23, the second display section 24, the first display section 106 and the second display section 109 to display various screens. For example, the display control section 618 displays a commodity registration screen 1000 on the first display section 106. The display control section 618 displays an operation section through which the commodity specified by the commodity code is registered with the commodity registration section 617 on the commodity registration screen 1000 based on various information registered in the sales registration table 73 by the commodity registration section 617.

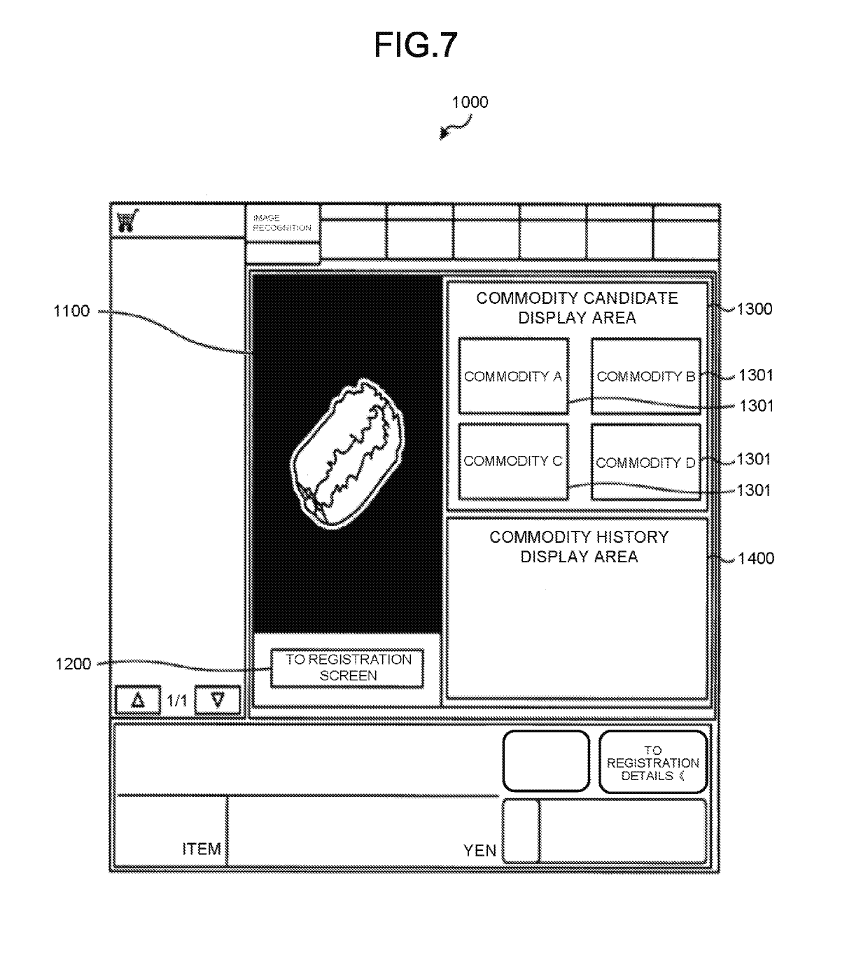

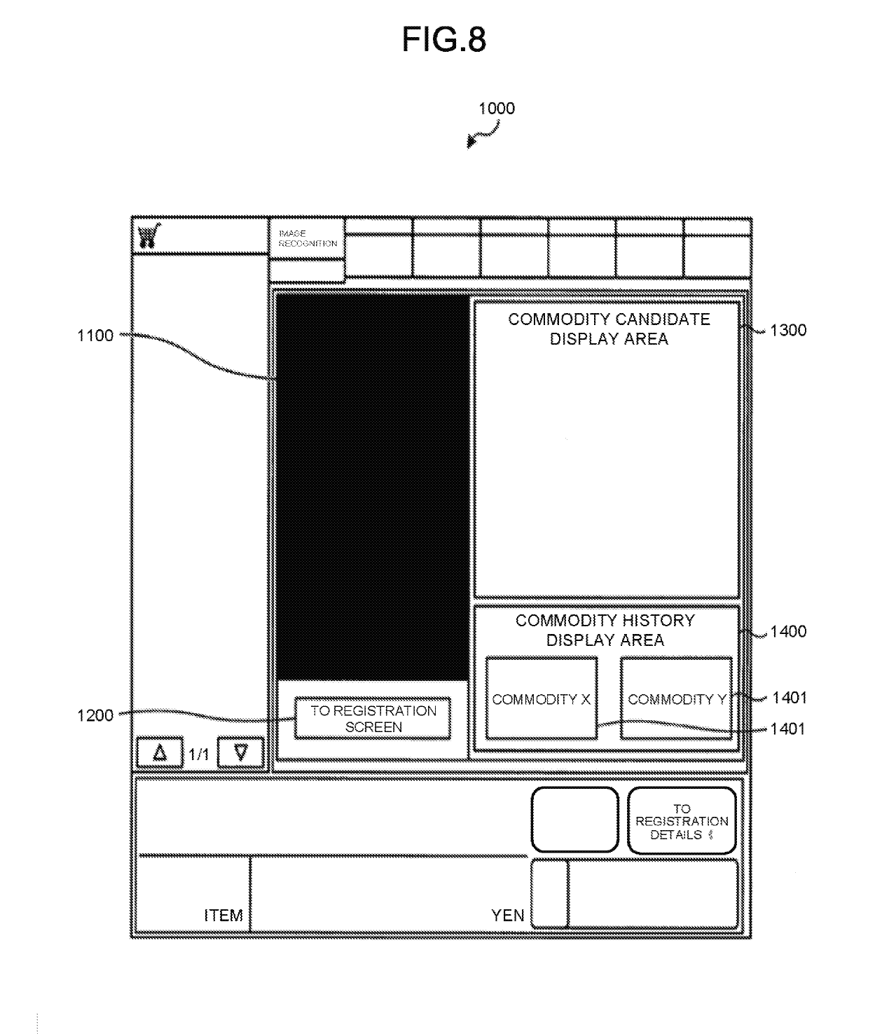

FIG. 7 is a view illustrating an example of the commodity registration screen 1000. The commodity registration screen 1000 is used to register the commodity code of the commodity subject to be sold. The commodity registration screen 1000 includes a captured image display area 1100, a registration screen button 1200, a commodity candidate display area 1300 and a registration history display area 1400. The captured image display area 1100 is used to display the image data the input of which is received by the image acquisition section 611. In other words, the captured image display area 1100 displays the image data captured by the image capturing section 164. The registration screen button 1200 is used to display a screen for executing the sales registration on the commodity subject to be sold by pressing a button of a commodity selected from a list of commodities. The commodity candidate display area 1300 displays commodity candidate buttons 1301. The commodity candidate button 1301 is an operation section for instructing the execution of the sales registration on the commodity, the commodity candidate, designated by the commodity identification section 616 as the commodity to be sold. The registration history display area 1400 displays registration history buttons 1401 (refer to FIG. 8). The registration history button 1401 is an operation section for instructing the execution of the sales registration on the commodity specified by the commodity code stored in the sales registration table 73 as the commodity to be sold. The commodity registration screen 1000 shown in FIG. 7 does not display the registration history button 1401 because it is assumed that the commodity code is not stored in the sales registration table 73.

FIG. 8 is a view illustrating an example of the commodity registration screen 1000 in a state in which the commodity code is stored in the sales registration table 73. The display control section 618, i.e., a display control module, displays the registration history button 1401, the operation section, for enabling the commodity registration section 617 to register the commodity specified by the commodity code on the commodity registration screen 1000 based on various information registered in the sales registration table 73 by the commodity registration section 617. The commodity registration screen 1000 shown in FIG. 8 displays the registration history button 1401 because it is assumed that the commodity code is stored in the sales registration table 73. The display control section 618 displays the registration history button 1401 for executing the sales registration on the commodity specified by the commodity code as the commodity subject to be sold on condition that the commodity code is stored in the sales registration table 73. In other words, the display control section 618 displays the registration history button 1401 regardless of whether the commodity identification section 616 extracts the commodity candidate. Thus, the commodity registration screen 1000 shown in FIG. 8 displays the registration history button 1401 even in a state in which the commodity candidate button 1301 is not displayed in the commodity candidate display area 1300 and the commodity is not photographed and also displayed in the captured image display area 1100.

The display control section 618 displays the registration history button 1401 for executing the sales registration on a part or all of commodities stored in the sales registration table 73 as the commodity to be sold in the registration history display area 1400. All the registration history buttons 1401 can be displayed by scrolling the registration history display area 1400 through the display control section 618 in a case in which the registration history display area 1400 is too small to display all the registration history buttons 1401. Alternatively, the display control section 618 displays the remaining registration history buttons 1401 on anther screen. The display control section 618 may display the commodity selected from the commodities stored in the sales registration table 73 in the registration history display area 1400. For example, the display control section 618 displays the registration history button 1401 of a commodity to which the sales registration is executed recently. Alternatively, the display control section 618 displays the registration history button 1401 selected in such an algorithm that the registration history button 1401 recently used is left and the registration history button 1401 which is not used is deleted in the registration history display area 1400.

The operation control section 619 controls a part or all of the keyboard 22, the touch panel 26, the touch panel 105 and the keyboard 107 to receive various operations.

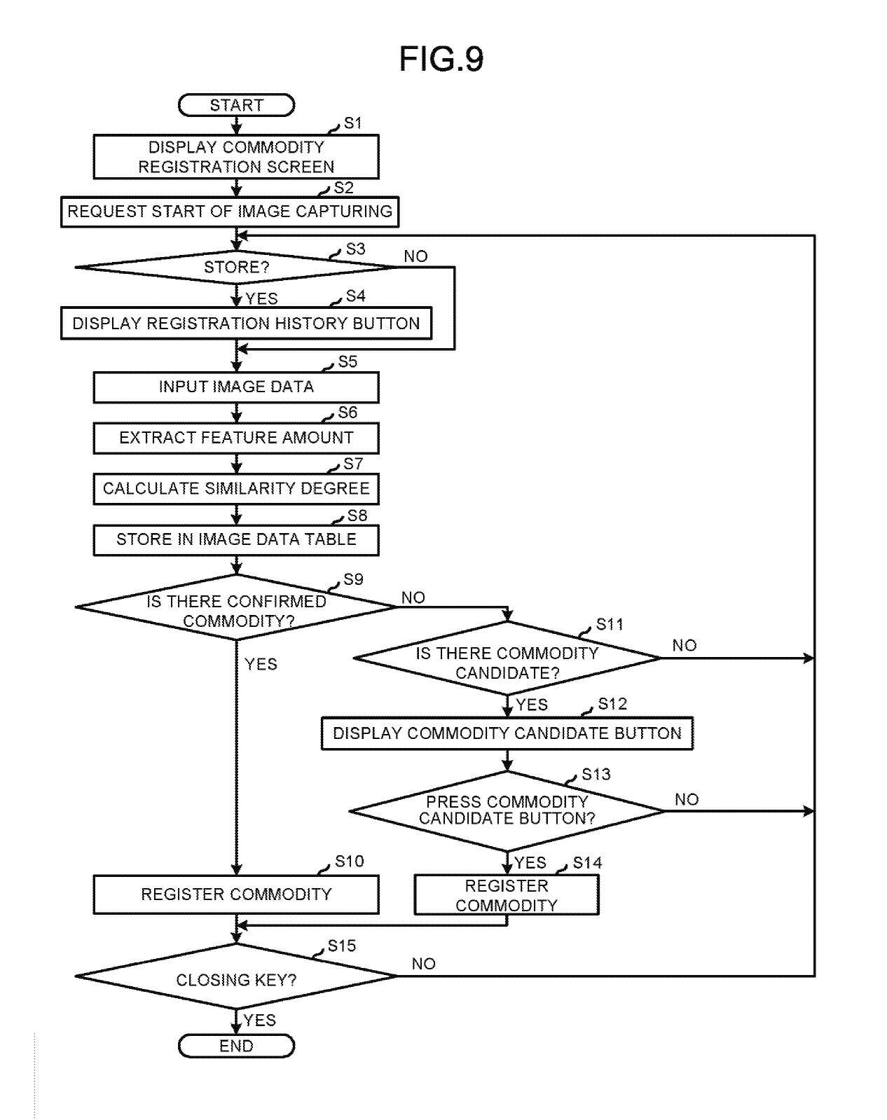

Next, the commodity registration processing executed by the POS terminal 11 is described. FIG. 9 is a flow chart illustrating an example of the commodity registration processing executed by the POS terminal 11 according to the first embodiment.

The display control section 618 of the POS terminal 11 displays the commodity registration screen 1000 (Act S1).

The image acquisition section 611 of the POS terminal 11 requests the commodity reading section 110 to start the image capturing by the image capturing section 164 (Act S2).

The display control section 618 of the POS terminal 11 determines whether or not the commodity code is stored in the sales registration table 73 (Act S3). If the commodity code is not stored in the sales registration table 73 (No in Act S3), the POS terminal 11 proceeds to the processing in Act S5.

On the other hand, if the commodity code is stored in the sales registration table 73 (Yes in Act S3), the display control section 618 of the POS terminal 11 displays the registration history button 1401 in the registration history display area 1400 (Act S4). In other words, the display control section 618 displays the registration history button 1401 for executing the sales registration on the commodity specified by the commodity code registered in the sales registration table 73.

The image acquisition section 611 of the POS terminal 11 receives the input of the image data captured by the image capturing section 164 from the commodity reading section 110 (Act S5). The feature amount extraction section 613 of the POS terminal 11 extracts the feature amount of the commodity detected by the commodity detection section 612 (Act S6). The similarity degree calculation section 614 of the POS terminal 11 calculates the similarity degree for each commodity by comparing the feature amount extracted by the feature amount extraction section 613 and the feature amount for comparison of each commodity in the PLU file 71 (Act S7).

The storage control section 615 of the POS terminal 11 stores the similarity degree, the feature amount, the image data, and the commodity code of the commodity with the highest similarity degree in the image data table 72 (Act S8).

The commodity identification section 616 of the POS terminal 11 determines whether or not the confirmed commodity can be extracted based on the similarity degree (Act S9). If the confirmed commodity can be extracted (Yes in Act S9), the commodity registration section 617 of the POS terminal 11 sales-registers the extracted confirmed commodity as the commodity subject to be sold in the sales registration table 73 (Act S10).

On the other hand, if the confirmed commodity cannot be extracted (No in Act S9), the commodity identification section 616 of the POS terminal 11 determines whether or not the commodity candidate can be extracted based on the similarity degree (Act S11). If the commodity candidate cannot be extracted (No in Act S11), the POS terminal 11 proceeds to the processing in Act S3.

On the other hand, if the commodity candidate can be extracted (Yes in Act S11), the display control section 618 of the POS terminal 11 displays the commodity candidate button 1301 for executing the sales registration on the extracted commodity candidate in the commodity candidate display area 1300 (Act S12).

The commodity registration section 617 of the POS terminal 11 determines whether or not the commodity candidate button 1301 is pressed (Act S13). If the commodity candidate button 1301 is not pressed (No in Act S13), the POS terminal 11 proceeds to the processing in Act S3.

On the other hand, if the commodity candidate button 1301 is pressed (Yes in Act S13), the commodity registration section 617 of the POS terminal 11 sales-registers the commodity associated with the commodity candidate button 1301 as the commodity subject to be sold in the sales registration table 73 (Act S14).

The operation control section 619 of the POS terminal 11 determines whether or not the pressing of a closing key is detected (Act S15). If the pressing of the closing key is not detected (No in Act S15), the POS terminal 11 proceeds to the processing in Act S3.

On the other hand, if the pressing of the closing key is detected (Yes in Act S15), the POS terminal 11 ends the commodity registration processing.

Through the above, the POS terminal 11 ends the commodity registration processing.

As stated above, in accordance with the POS terminal 11 according to the first embodiment, the commodity registration section 617 registers the commodity code of the commodity selected from the commodity candidates extracted by the commodity identification section 616 in the sales registration table 73. The display control section 618 displays the commodity registration screen 1000 for executing the sales registration on the commodity based on the commodity code registered in the sales registration table 73. More specifically, the display control section 618 displays the registration history button 1401 for registering the commodity specified by the commodity code registered in the sales registration table 73 on the commodity registration screen 1000. Therefore, in a case in which the operator of the POS terminal 11 executes the sales registration again to the commodity already sales-registered, the sales registration can be executed to the commodity without holding the commodity over the image capturing section 164. Therefore, the commodity can be easily registered through the POS terminal 11.

### Second Embodiment

Next, the second embodiment is described. The description of differences from the first embodiment is mainly given, and the components having the same functions as those in the first embodiment are donated with the same names and reference numerals as in the first embodiment, and the description thereof is omitted.

The POS terminal 11 according to the second embodiment displays the commodity candidate button 1301 at the same position as in the previous general object recognition in the commodity candidate display area 1300 on condition that the commodities belonging to the same category are already sales-registered by the general object recognition.

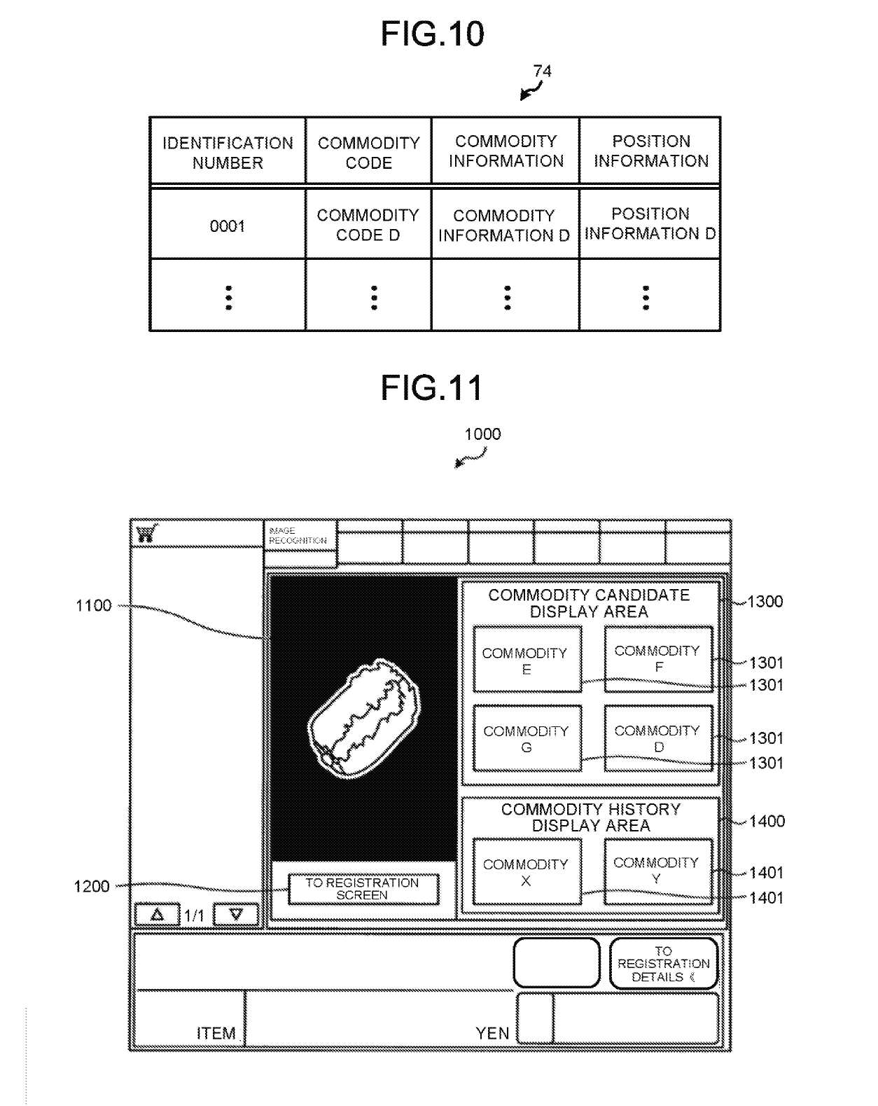

The commodity registration section 617 stores various information of the commodity to which the sales registration is executed in a sales registration table 74 on condition that the sales registration is executed to the commodity selected from the commodity candidates identified by the commodity identification section 616 through the general object recognition. FIG. 10 is a view illustrating an example of the data structure of the sales registration table 74 according to the second embodiment. The sales registration table 74 stores the identification number, the commodity code, the commodity information, and position information in an associated manner. The identification number, the commodity code and the commodity information in the sales registration table 74 according to the second embodiment are the same as those in the sales registration table 73 according to the first embodiment. The position information indicates a position where the commodity candidate button 1301 is displayed in the commodity candidate display area 1300.

The display control section 618 displays the commodity registration screen 1000. The display control section 618 displays the commodity candidate button 1301, i.e., an operation section, for enabling the commodity registration section 617 to register the commodity specified by the commodity code in the commodity candidate display area 1300 based on various information registered in the sales registration table 74 by the commodity registration section 617. More specifically, the display control section 618 displays the commodity candidate button 1301 at a position indicated by the position information associated with the commodity code on condition that the corresponding commodity code of the commodity candidate extracted by the commodity identification section 616 is contained in the sales registration table 74. On the other hand, the display control section 618 displays the commodity candidate button 1301 at a position based on a predetermined rule on condition that the corresponding commodity code of the commodity candidate extracted by the commodity identification section 616 is not contained in the sales registration table 74. The predetermined rule is, for example, an order of the similarity degrees of the extracted commodity candidates.

FIG. 11 is a view illustrating an example of the commodity registration screen 1000. The commodity registration screen 1000 shown in FIG. 11 displays the commodity candidate buttons 1301 of a commodity E, a commodity F, a commodity G and a commodity D in the commodity candidate display area 1300. A commodity code of the commodity D is registered in the sales registration table 74. The levels of the similarity degrees of the commodity D, the commodity E, the commodity F and the commodity G are in the order thereof. Thus, the display control section 618 displays the commodity D at the position of the commodity E shown in FIG. 11, the commodity E at the position of the commodity F, the commodity F at the position of the commodity G, the commodity G at the position of the commodity D if the commodity D is not registered in the sales registration table 74. However, the display control section 618 displays the commodity D at the position shown in FIG. 11 on condition that the commodity code of the commodity D is registered in the sales registration table 74. Furthermore, the commodity registration screen 1000 according to the second embodiment may not include the registration history display area 1400.

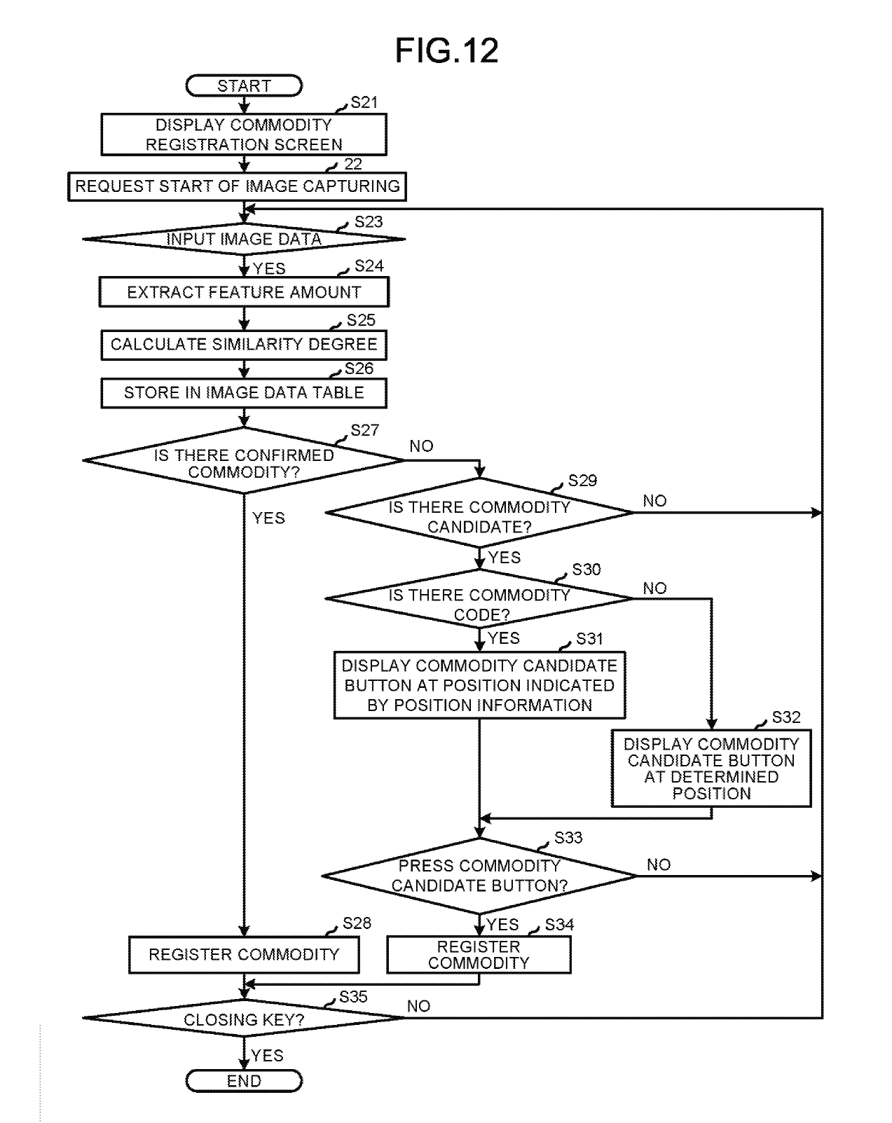

Next, the commodity registration processing executed by the POS terminal 11 according to the second embodiment is described. FIG. 12 is a flowchart illustrating an example of the commodity registration processing executed by the POS terminal 11 according to the second embodiment.

The display control section 618 of the POS terminal 11 displays the commodity registration screen 1000 (Act S21).

The image acquisition section 611 of the POS terminal 11 requests the commodity reading section 110 to start the image capturing by the image capturing section 164 (Act S22).

The processing from Act S23 to Act S29 are the same as those from Act S5 to Act S10 according to the first embodiment.

The display control section 618 of the POS terminal 11 determines whether or not the commodity code of the extracted commodity candidate is contained in the sales registration table 74 (Act S30). If the commodity code of the extracted commodity candidate is contained in the sales registration table 74 (Yes in Act S30), the display control section 618 of the POS terminal 11 displays the commodity candidate button 1301 at the position indicated by the position information (Act S31).

On the other hand, if the commodity code of the extracted commodity candidate is not contained in the sales registration table 74 (No in Act S30), the display control section 618 of the POS terminal 11 displays the commodity candidate button 1301 at the position based on the predetermined rule (Act S32).

The operation control section 619 of the POS terminal 11 determines whether or not the commodity candidate button 1301 is pressed (Act S33). If the commodity candidate button 1301 is not pressed (No in Act S33), the POS terminal 11 proceeds to the processing in Act S23.

On the other hand, if the commodity candidate button 1301 is pressed (Yes in Act S33), the commodity registration section 617 of the POS terminal 11 sales-registers the commodity associated with the commodity candidate button 1301 as the commodity subject to be sold in the sales registration table 74 (Act S34).

The operation control section 619 of the POS terminal 11 determines whether or not the pressing of the closing key is detected (Act S35). If the pressing of the closing key is not detected (No in Act S35), the POS terminal 11 proceeds to the processing in Act S23.

On the other hand, if the pressing of the closing key is detected (Yes in Act S35), the POS terminal 11 ends the commodity registration processing.

Through the above, the POS terminal 11 ends the commodity registration processing.

As stated above, in accordance with the POS terminal 11 according to the second embodiment, the commodity registration section 617 registers the commodity code, the commodity information and the position information in the sales registration table 74 on condition that the commodity selected from the commodity candidates extracted by the commodity identification section 616 is sales-registered. The display control section 618 displays the commodity candidate button 1301 at the position indicated by the position information on condition that the commodity code of the commodity candidate is contained in the sales registration table 74 in a case in which the commodity candidate button 1301 for registering the commodity candidate extracted by the commodity identification section 616 is displayed. In other words, the display control section 618 displays the commodity candidate button 1301 at a position displayed at a last time. Thus, the POS terminal 11 can reduce a pressing error of the commodity candidate button 1301 by displaying the commodity candidate button 1301 at the same position in a case in which the same commodity is sales-registered. Therefore, the POS terminal 11 can easily register the object.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

In the above embodiment, the POS terminal 11 is applied as the information processing apparatus having distinctive functions (the image acquisition section 611, the commodity detection section 612, the feature amount extraction section 613, the similarity degree calculation section 614, the storage control section 615, the commodity identification section 616, the commodity registration section 617, the display control section 618 and the operation control section 619). However, the present invention is not limited to this, for example, the commodity reading apparatus 101 may be applied as the information processing apparatus having these distinctive functions described above. Furthermore, these distinctive functions may be divided to the POS terminal 11 and the commodity reading apparatus 101.

In the above embodiment, a case in which the POS terminal carries out the sales registration on the commodity identified through the general object recognition (object recognition) is described as an example. However, the POS terminal 11 may identify the commodity through other methods except for the general object recognition (object recognition). For example, the POS terminal 11 may sales-register the commodity designated by the code symbol such as a barcode, or may sales-register the commodity designated by the commodity code input through numeric keys. In a case in which the commodity specified with the commodity code represented by the barcode is registered, the POS terminal 11 stores the commodity code specifying the commodity in the sales registration table 73. The POS terminal 11 displays the registration history button 1401 for sales-registering the commodity of which the commodity code is stored in the sales registration table 73. Thus, the POS terminal 11 can execute the sales registration on a plurality of the same commodities without reading the barcode of the same commodity more than once.

In the above embodiment, a case in which the data for comparison is the feature amount is described; however, the data for comparison may also be a captured commodity image (reference image).

In the above embodiment, the display control section 618 displays the commodity candidate button 1301 in the commodity candidate display area 1300. The display control section 618 also displays the registration history button 1401 in the registration history display area 1400. However, the display control section 618 may not distinguish the commodity candidate display area 1300 from the registration history display area 1400 on the commodity registration screen 1000. In other words, the display control section 618 may display the commodity candidate button 1301 and the registration history button 1401 in the same display area.

In the above embodiment, the commodity registration section 617 stores the position information indicating the position of the commodity candidate button 1301 in the sales registration table 74 on condition that the commodity candidate button 1301 is pressed. Then, the display control section 618 displays the commodity candidate button 1301 at the same position as the indication of the position information on condition that the commodity of the commodity candidate extracted by the commodity identification section 616 is included in the sales registration table 74. However, the commodity registration section 617 may store the position information indicating the position of the registration button in the sales registration table 74 even in a case in which a registration button for registering the commodity other than the commodity candidate button 1301 is pressed. For example, the commodity registration section 617 may store the position information indicating the position of the registration history button 1401 in the sales registration table 74 on condition that the registration history button 1401 is pressed. In this case, the display control section 618 displays the registration history button 1401 at the position indicated by the position information stored in the sales registration table 74.

In the above embodiment, the present invention is applied to the checkout system 1 including the POS terminal 11 and the commodity reading apparatus 101. However, the present invention is not limited to this. The invention may be applied to a single apparatus equipped with the functions of the POS terminal 11 and the commodity reading apparatus 101. As the single apparatus having the functions of the POS terminal 11 and the commodity reading apparatus 101, a self-checkout apparatus (hereinafter, simply referred to as a self-checkout POS terminal) installed in a store such as a supermarket is exemplified.

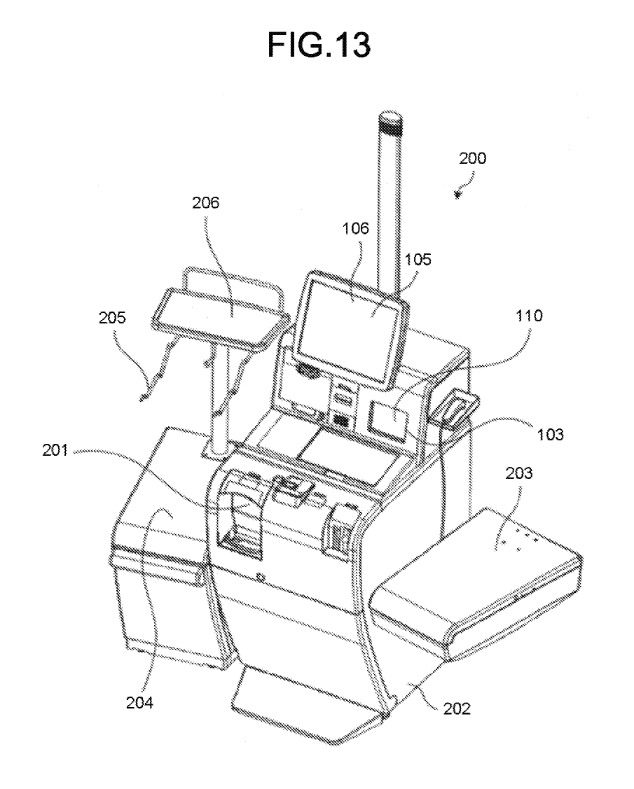

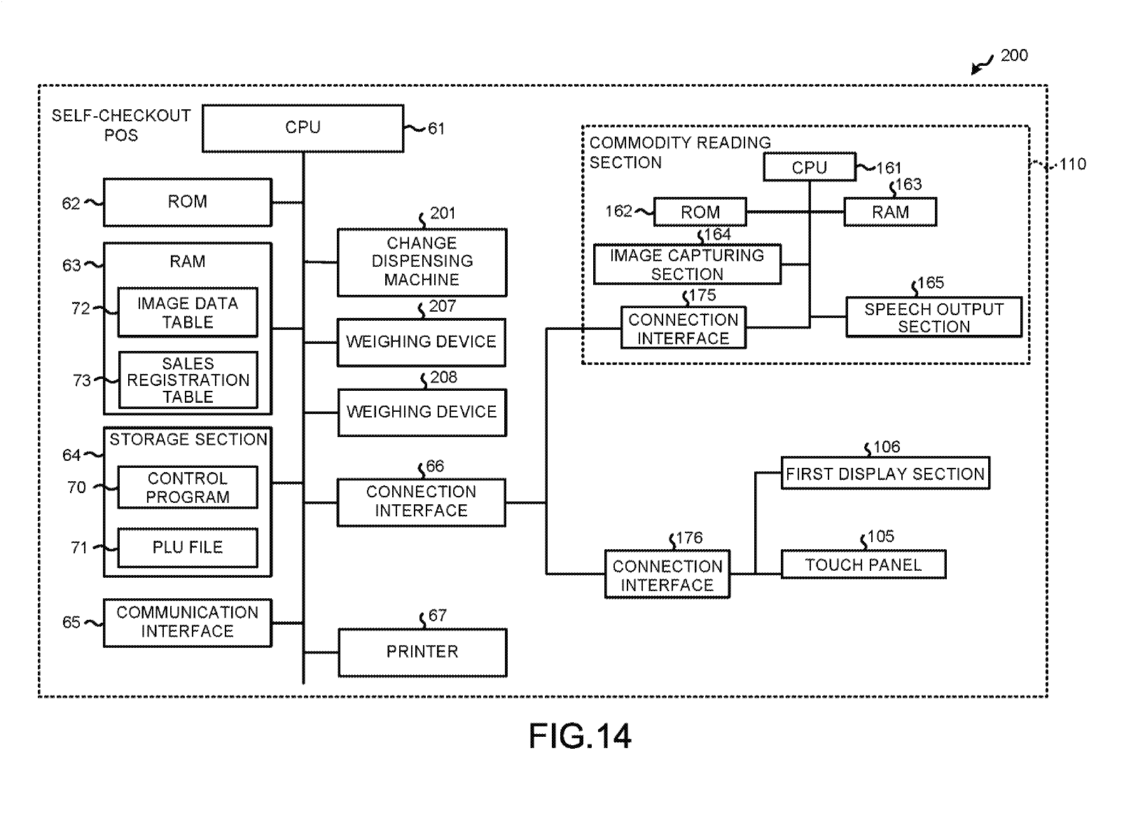

FIG. 13 is a perspective view illustrating an example of the constitution of a self-checkout POS terminal 200. FIG. 14 is a block diagram illustrating an example of the hardware structure of the self-checkout POS terminal 200. Hereinafter, the same components as in FIG. 1 and FIG. 2 are donated with the same reference numerals, and the repeated description thereof is omitted. As shown in FIG. 13 and FIG. 14, a main body 202 of the self-checkout POS terminal 200 is provided with the first display section 106 on the surface of which the touch panel 105 is installed and the commodity reading section 110 for reading a commodity image to recognize (detect) a category of the commodity.

The first display section 106 is, for example, a liquid crystal display. The first display section 106 displays the commodity registration screen 1000. The first display section 106 displays the registration history button 1401 for executing the sales registration on a part or all of the commodities stored in the sales registration table 73 as the commodity subject to be sold in the registration history display area 1400. Alternatively, the first display section 106 displays the commodity candidate button 1301 at the position indicated by the position information associated with the commodity code on condition that the corresponding commodity code of the commodity candidate extracted by the commodity identification section 616 is contained in the sales registration table 73. Alternatively, the first display section 106 displays a guidance screen for instructing an operation method of the self-checkout POS terminal 200 to a customer, various input screens and the registration screen for displaying the commodity information read by the commodity reading section 110. Alternatively, the first display section 106 displays a total amount of the commodities, a deposited amount and a change amount, and also displays a settlement screen for selecting a payment method.

The commodity reading section 110 reads the commodity image with the image capturing section 164 by holding a code symbol attached to the commodity over the reading window 103 of the commodity reading section 110 by the customer.

The self-checkout POS terminal 200 is provided with a commodity placement table 203 for placing unsettled commodities put in a basket at the right side of the main body 202. The self-checkout POS terminal 200 is provided with a commodity placement table 204 for placing settled commodities at the left side of the main body 202. The commodity placement table 204 includes a bag hook 205 for hanging bag for putting the settled commodities and a temporary placement table 206 for temporarily placing the settled commodities before the settled commodities are put in the bag. The commodity placement tables 203 and 204 are respectively provided with weighing devices 207 and 208, and have a function of confirming that the weight of commodities is the same before and after the settlement.

The main body 202 of the self-checkout POS terminal 200 is provided with a change dispensing machine 201 for depositing bills for settlement and receiving change bills.

In a case of applying the self-checkout POS terminal 200 with such a constitution to the checkout system 1, the self-checkout POS terminal 200 functions as the information processing apparatus.

The programs executed by each device of the foregoing embodiment and the modification may be incorporated into a storage medium (ROM or storage section) of each device to be provided; however, the present invention is not limited to this. The programs may be recorded in a computer-readable recording medium such as a CD-ROM, a FD (Flexible Disk), a CD-R, a DVD (Digital Versatile Disk) and the like in the form of installable or executable file to be provided. Further, the storage medium is not limited to a medium independent of a computer or an embedded system and also contains a storage medium that stores or temporarily stores the programs by downloading the programs transmitted through a LAN or an Internet.

Further, the programs executed by each device of the foregoing embodiment and the modification is stored in a computer connected with a network and downloaded via the network to be supplied or may be supplied or distributed via the network such as the Internet.

What is claimed is:

1. An image processing apparatus, comprising:
a designation module configured to designate an object;
a registration module configured to register information of the object designated by the designation module; and
a display control module configured to enable a display section to display an operation section for instructing the registration module based on the information registered by the registration module.

2. The image processing apparatus according to claim 1, wherein the display control module displays the operation section for registering the object belonging to the same category as the object registered by the registration module on a registration screen for displaying the operation section for registering the object designated by the designation module.

3. The image processing apparatus according to claim 1, wherein the registration module registers position information indicating a position where the operation section is displayed and the information of the object specified by the operation section in an associated manner on condition that the object instructed by the operation section is registered, and the display control module displays the operation section at a position indicated by the position information.

4. The image processing apparatus according to claim 2, wherein the registration module registers position information indicating a position where the operation section is displayed and the information of the object specified by the operation section in an associated manner on condition that the object instructed by the operation section is registered, and the display control module displays the operation section at a position indicated by the position information.

5. The image processing apparatus according to claim 3, wherein the display control module displays one or a plurality of the operation sections for registering the object designated by the designation module at positions indicated by the position information.

6. The image processing apparatus according to claim 1, further comprising:
a detection module configured to detect the object contained in an image data captured by an image capturing section; and
an extraction module configured to extract the object corresponding to the object detected by the detection module based on a similarity degree between a feature amount of the object extracted from the image data and the feature amount of various objects for comparison as to the object detected by the detection module, wherein
the designation module designates the object extracted by the extraction module.

7. A method for easily registering an object, including:
designating an object;
registering information of the designated object; and
displaying an operation section for instructing the registration based on the registered information.
